(19) United States
(12) Patent Application Publication
(10) Pub. No.: US 2006/0019129 A1
(43) Pub. Date: Jan. 26, 2006

(54) Planar fuel cell assembly

(75) Inventors: Hsi-An Liu, Taoyuan Hsien (TW); Sheng-Yan Hu, Taoyuan Hsien (TW); Chen-Yu Yu, Taoyuan Hsien (TW)

Correspondence Address: MADSON & METCALF;GATEWAY TOWER WEST, SUITE 900, 15 WEST SOUTH TEMPLE, SALT LAKE CITY, UT, 84101, US

(73) Assignee: Delta Electronics, Inc.

(21) Appl. No.: 11/023,778

(22) Filed: Dec. 28, 2004

(30) Foreign Application Priority Data
Jul. 22, 2004 (TW) 093121932

(51) Int. Cl. H01M 8/00

(52) U.S. Cl. 429/12; 429/34; 429/36

(57) ABSTRACT

A planar fuel cell assembly includes a plurality of fuel cell units and a first channel-forming plate. The plurality of fuel cell units are connected in series. Each fuel cell unit includes a meshed metal plate and a membrane-electrolyte assembly. The membrane-electrolyte assembly of each fuel cell unit has a first side in contact with a second portion of the meshed metal plate and a second side in contact with a first portion of the meshed metal plate of an adjacent fuel cell unit. The first channel-forming plate cooperates with the plurality of fuel cell units to define a channel for flowing a fluid fuel therethrough.

### FIELD OF THE INVENTION

The present invention relates to a planar fuel cell assembly, and more particularly to a planar fuel cell assembly which is easily fabricated and suitable for mass production.

### BACKGROUND OF THE INVENTION

Fuel cells are well known and commonly used to produce electrical energy by means of electrochemical reactions. Comparing to the conventional power generation apparatus, fuel cells have advantages of less pollutant, lower noise generated, increased energy density and higher energy conversion efficiency. Fuel cells can be used in portable electronic products, home-use or plant-use power generation systems, transportation, military equipment, space industry, large-size power generation systems, etc.

According to the electrolytes, fuel cells are typically classified into several types, e.g. an alkaline fuel cell (AFC), a phosphoric acid fuel cell (PAFC), a molten carbonate fuel cell (MCFC), a solid oxide fuel cell (SOFC) and a proton exchange membrane fuel cell (PEMFC). Depending on types of the fuel cells, the operation principles are somewhat different. For example, in the case of a direct methanol fuel cell (DMFC) which has the same structure as the PEMFC but uses liquid methanol instead of hydrogen as a fuel source, methanol is supplied to the anode, an oxidation reaction occurs in the presence of a catalyst, and protons, electrons and carbon dioxide are generated. The protons reach the cathode through the proton exchange membrane. Meanwhile, in the cathode, oxygen molecules take electrons from the anode and are reduced to oxygen ions by reduction. The oxygen ions react with hydrogen ions from the anode and thus produce water.

As know, an individual fuel cell unit supplies limited voltage (approximately 0.4 V). For a purpose of offering a sufficient operating voltage to an electronic product, a plurality of fuel cell units are connected in series so as to form a fuel cell assembly. Depending on the arrangement of the fuel cell units, the fuel cell assemblies can be divided into two types, i.e. a stacked fuel cell assembly and a planar fuel cell assembly.

Referring to FIG. 1, an exploded view of a conventional stacked fuel cell assembly is illustrated. The stacked fuel cell assembly 10 comprises at least two membrane-electrolyte assemblies (MEAs) 11, a bipolar plate 12 located between two adjacent MEAs 11 and two electrode plates 13 and 14 at opposite ends of the fuel cell assembly. Each MEA 11 includes an anode 111, a proton exchange membrane 112 and a cathode 113. The bipolar plate 12 comprises a plurality of channels 121 for flowing fuels and oxygen molecules therethrough. However, since the stacked fuel cell assembly 10 requires a large amount of cell units to be assembled in a stacked form, the thickness and the weight thereof are considerably high. Therefore, the usage of such stacked fuel cell assembly is restricted in some situations.

Referring to FIG. 2, an exploded view of a conventional planar fuel cell assembly is illustrated. The planar fuel cell assembly 20 comprises a metal frame 21, a plurality of membrane-electrolyte assemblies (MEAs) 22 and two electrode plates 23 and 24 at opposite ends of the fuel cell assembly. Likewise, each MEA 22 includes an anode, a proton exchange membrane and a cathode (not shown), and is embedded in the corresponding opening 211 of the frame 21. Furthermore, two current collectors 212 are disposed at one side of the frame 21 as the current output terminals of the planar fuel cell assembly 20. Each of the electrode plates 23 and 24 comprises channels 231 for flowing fuels and oxygen molecules therethrough. However, the metal frame 21 used in the planar fuel cell assembly 20 is both bulky and weighty. In addition, the procedure of aligning the MEAs 22 in the corresponding openings 211 of the frame 21 is complex and time-consuming. Such planar fuel cell assembly 20 is costly to manufacture, and also contribute a substantial weight and volume to the overall fuel cell assembly. In other words, such planar fuel cell assembly fails to be used in portable electronic products.

### SUMMARY OF THE INVENTION

The present invention provides a planar fuel cell assembly, which is easily fabricated and suitable for mass production.

In accordance with the present invention, there is provided a planar fuel cell assembly. The planar fuel cell assembly comprises a plurality of fuel cell units and a first channel-forming plate. The plurality of fuel cell units are connected in series. Each fuel cell unit comprises a meshed metal plate and a membrane-electrolyte assembly. The membrane-electrolyte assembly of each fuel cell unit has a first side in contact with a second portion of the meshed metal plate and a second side in contact with a first portion of the meshed metal plate of an adjacent fuel cell unit. The first channel-forming plate cooperates with the plurality of fuel cell units to define a channel for flowing a fluid fuel therethrough.

In an embodiment, the meshed metal plate of each fuel cell unit is fabricated by punching a plurality holes in a metal piece.

In an embodiment, the first channel-forming plate is integrally formed of a plastic material by an injection molding process.

In an embodiment, each membrane-electrolyte assembly includes an anode, a proton exchange membrane and a cathode.

Preferably, the fluid fuel is in a gaseous or liquid state.

In an embodiment, the first portion and the second portion of the meshed metal plate are disposed at different levels by a gap.

In an embodiment, an edge of the membrane-electrolyte assembly is bonded to a connection portion between the first portion and the second portion of the meshed metal plate.

In an embodiment, the edge of the membrane-electrolyte assembly is bonded to the connection portion via an adhesive material.

In an embodiment, the second side of the membrane-electrolyte assembly is in contact with the first portion of the meshed metal plate of the adjacent fuel cell unit such that the top surface of the first portion of the adjacent fuel cell unit is substantially at the same level as that of the fuel cell unit.

In an embodiment, the first channel-forming plate comprises a depression portion enclosed by protruding edges thereof and a plurality of raised rods provided on the depression portion, wherein the raised rods along with the depression portion and the protruding edges define the channel for flowing the fluid fuel therethrough.

In an embodiment, a plurality of supporting blocks are disposed beside the protruding edges and the raised rods for supporting the plurality of fuel cell units.

In an embodiment, the plurality of fuel cell units are connected with the supporting blocks via an adhesive material.

In an embodiment, the planar fuel cell assembly further comprises a decorative plate disposed on the plurality of fuel cell units and the first channel-forming plate.

In an embodiment, the decorative plate and the first channel-forming plate are bonded together by means of an ultrasonic welding technique.

In an embodiment, the decorative plate is secured to the first channel-forming plate by tenons, screws or resilience sheets.

In an embodiment, the decorative plate is made of a plastic material.

In an embodiment, the first channel-forming plate further comprises weld lines corresponding to the periphery of the plurality of fuel cell units so as to facilitate sealing the fuel cell units and prevent leakage of the fluid fuel.

In an embodiment, the planar fuel cell assembly further comprises a second channel-forming plate disposed on the plurality of fuel cell units and the first channel-forming plate, the structures of the second channel-forming plate and the first channel-forming plate being substantially identical.

In an embodiment, the planar fuel cell assembly further comprises a blower disposed at an inlet of the second channel-forming plate for enhancing the flow rate of the air flowing through the second channel-forming plate.

In an embodiment, the planar fuel cell assembly further comprises two current collectors connected to the two terminal fuel cell units and acting as the current output terminals of the planar fuel cell assembly.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is an exploded view of a stacked fuel cell assembly according to prior art;

FIG. 2 is an exploded view of a planar fuel cell assembly according to prior art;

FIG. 3(A) is an exploded view of a fuel cell unit according to a preferred embodiment of the present invention;

FIG. 3(B) is a perspective view of the fuel cell unit in FIG. 3(A);

FIG. 4(A) is an exploded view illustrating a plurality of fuel cell units of FIG. 3(B) connected in series;

FIG. 4(B) is a perspective view of the series-connected fuel cell units in FIG. 4(A);

FIG. 5(A) is an exploded view illustrating a planar fuel cell assembly according to a first preferred embodiment-of the present invention;

FIG. 5(B) is a perspective view of the planar fuel cell assembly in FIG. 5(A);

FIG. 6(A) is an exploded view illustrating a planar fuel cell assembly according to a second preferred embodiment of the present invention;

FIG. 6(B) is a perspective view of the planar fuel cell assembly in FIG. 6(A);

FIG. 6(C) is a cross-sectional view of the channel-forming plate of FIG. 6(A) along the line AA;

FIG. 7(A) is an exploded view illustrating a planar fuel cell assembly according to a third preferred embodiment of the present invention; and

FIG. 7(B) is a perspective view of the planar fuel cell assembly in FIG. 7(A).

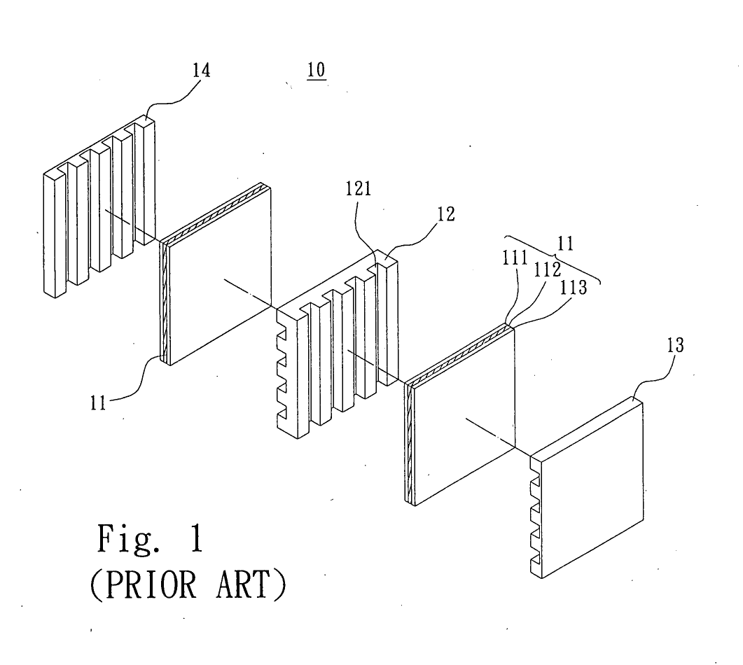

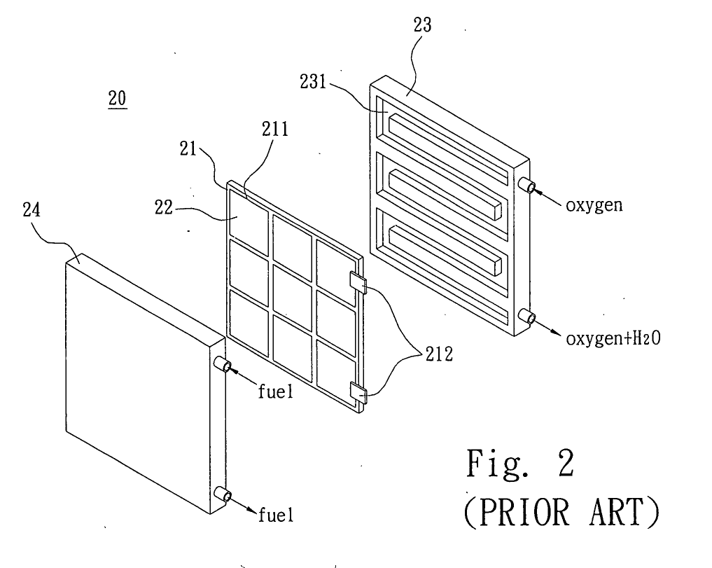

### DETAILED DESCRIPTION OF THE PREFERRED EMBODIMENT

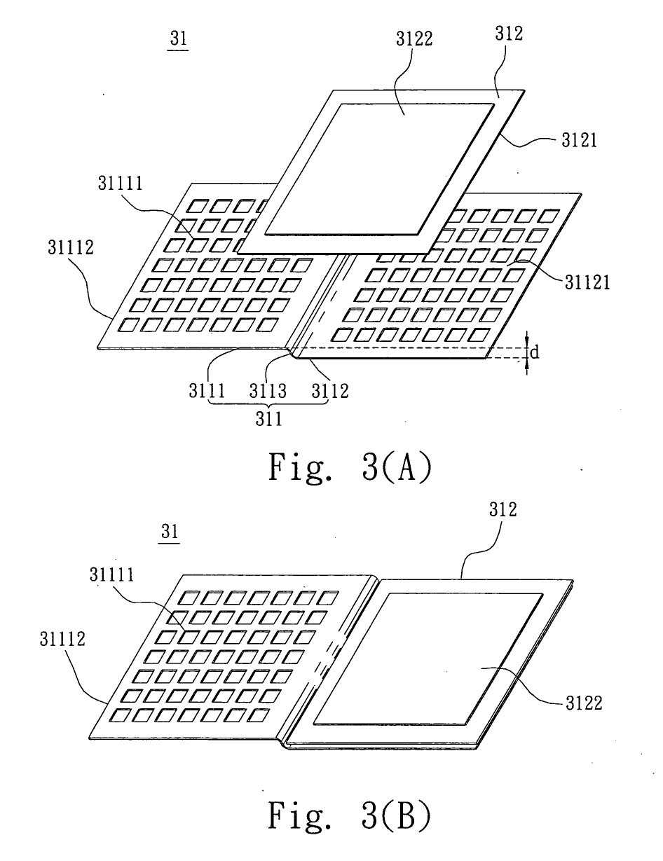

Referring to FIGS. 3(A) and 3(B), a fuel cell unit according to a preferred embodiment of the present invention is shown. In this embodiment, the fuel cell unit 31 comprises a meshed metal plate 311 and a membrane-electrolyte assembly (MEA) 312. The meshed metal plate 311 can be made by punching a plurality holes in a metal piece. Alternatively, the common metallic mesh can be used as the meshed metal plate 311. For a purpose of reducing cost, the meshed metal plate 311 can be made of an ignoble metal (for example iron or copper), and the surface of the meshed metal plate 311 can be coated with a noble metal (for example gold or silver) for corrosion protection. The meshed metal plate 311 comprises a first portion 3111 and a second portion 3112 disposed at different levels by a gap of “d”. The MEA 312 is disposed on the second portion 3112, and includes an anode, a proton exchange membrane and a cathode (not shown). The first side 3121 of the MEA 312 is in contact with the top surface 31121 of the second portion 3112. The edge of the MEA 312 is bonded to the connection portion 3113 between the first portion 3111 and the second portion 3112 by an adhesive dispensing machine (not shown). The second side 3122 of the MEA 312 is either an anode or a cathode to be electrically connected to the adjacent fuel cell unit.

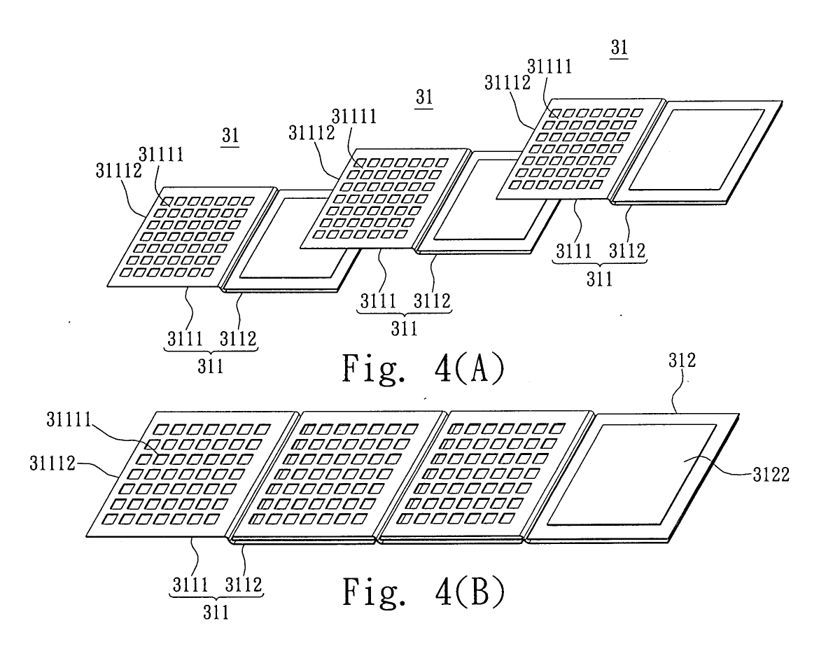

For a purpose of offering a sufficient operating voltage to an electronic product, a plurality of fuel cell units shown in FIG. 3(B) can be connected in series so as to form a fuel cell assembly. Please refer to FIGS. 4(A) and 4(B), which illustrate a plurality of fuel cell units connected in series. For neat drawings, however, only three fuel cell units 31 are shown in the drawing. Each fuel cell unit 31 is electrically connected to the previous one via the bottom surface 31112 of the first portion 3111, and electrically connected to the next one via the second side 3122 of the MEA 312. In such way, the top surfaces 31111 of the first portions 3111 of all fuel cell units 31 are substantially at the same level. Depending on the required operating voltage, the number of the fuel cell units 31 is varied.

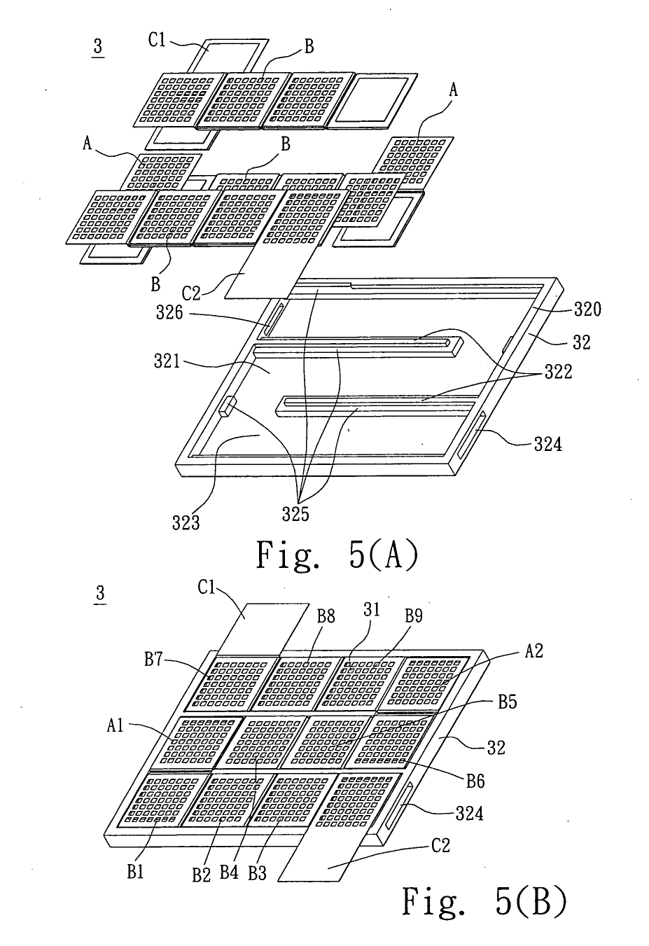

Since fuels are essentials for the fuel cell, the fuel cell assembly provided by the present invention further comprises a channel-forming plate 32, as is illustrated in FIGS. 5(A) and 5(B). The channel-forming plate 32 is integrally formed of a plastic material by an injection molding process. The channel-forming plate 32 comprises a depression portion 321 enclosed by the protruding edges 320 thereof. Several raised rods 322 are provided on the depression portion 321. The raised rods 322, along with the depression portion 321 and the protruding edges 320, define a channel 323 for flowing a fluid fuel therethrough. The channel-forming plate 32 is further provided with a fuel inlet 324 and a fuel outlet 326 on opposite edges thereof for introducing and discharging the fluid fuel, respectively. There are many supporting blocks 325 disposed beside the protruding edges 320 and the raised rods 322 for supporting the fuel cell units 31.

The fuel cell units 31 connected in series can be arranged in a line. Alternatively, the arrangement of the series-connected fuel cell units 31 can be changed as required. For example, as shown in FIGS. 5(A) and 5(B), the series-connected fuel cell units 31 comprises two type-A series-connected groups, three type-B series-connected groups and two current collectors C1 and C2. Each type-A series-connected group comprises one fuel cell unit arranged in the vertical direction. Whereas, each type-B series-connected group comprises three fuel cell units connected in the horizontal direction. For clarification, the designations A1˜A2 and B1˜B9 denote the first portions 3111 of the meshed metal plates 311 of the fuel cell units 31 for the type-A and type-B series-connected groups, respectively. The current collectors C1 and C2 act as the current output terminals of the planar fuel cell assembly 3.

After the fuel cell units 31 are connected in series and supported on the supporting blocks 325 of the channel-forming plate 32 as shown in FIG. 5(B), the connection portions between the supporting blocks 325 and the fuel cell units 31 are then sealed by the adhesive dispensing machine as described above. By the way, the top surface of the resulting planar fuel cell assembly 3 is exposed to the ambient air. Take a direct methanol fuel cell (DMFC) for example. During operation of such planar fuel cell assembly 3, methanol is supplied into the channel 323 of the channel-forming plate 32 via the fuel inlet 324. In the anode, an oxidation reaction occurs in the presence of a catalyst, and thus protons, electrons and carbon dioxide are generated. The protons reach the cathode through the proton exchange membrane to the cathode. The oxygen molecules containing in the air will flow through the meshed metal plate of the individual fuel cell unit to the cathode. Meanwhile, in the cathode, oxygen molecules take electrons from the anode and are reduced to oxygen ions by reduction. The oxygen ions react with hydrogen ions from the anode and thus produce water.

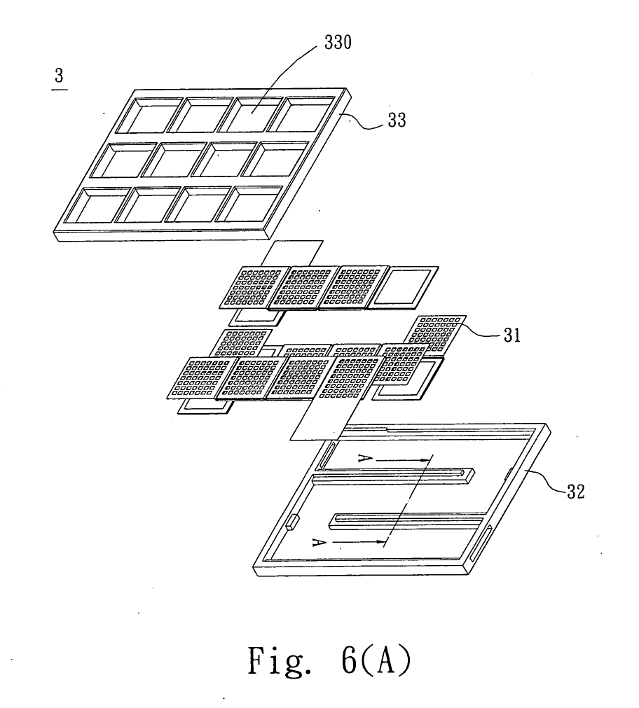

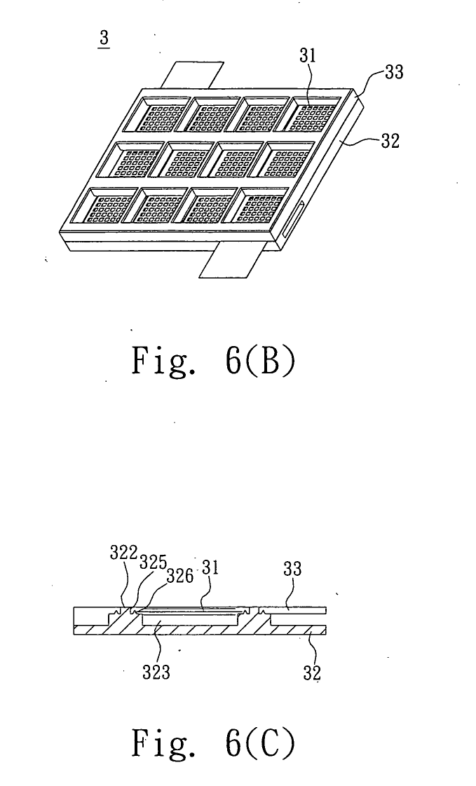

A further embodiment of a planar fuel cell assembly is illustrated in FIGS. 6(A)-6(C). In this embodiment, the arrangement of the series-connected fuel cell units 31 and the channel-forming plate 32 included therein are similar to those shown in FIG. 5, and are not to be redundantly described herein. However, a decorative plate 33 is further provided on the fuel cell units 31 and the channel-forming plate 32. The decorative plate 33 is made of plastic and comprises a plurality of hollow regions 330 for exposing the first portion 3111 of the individual meshed metal plate 311. The decorative plate 33 is preferably bonded to the channel-forming plate 32 by means of a well-known ultrasonic welding technique. Alternatively, the decorative plate 33 is secured to the channel-forming plate 32 by other means such as tenons, screws or resilience sheets. In addition, the supporting blocks 325 beside the raised rods 322 of the channel-forming plate 32 can be provided with weld lines 326, as shown in FIG. 6(C). When the ultrasonic welding technique is performed, the weld lines 326 will be melted and flow to the periphery of the fuel cell units 31 so as to facilitate sealing the fuel cell units 31 and prevent leakage of the fuel. When comparing with the conventional technology using the adhesive dispensing machine, the process of fixing the respective components of the planar fuel cell assembly 3 by using the ultrasonic welding technique is more convenient and simpler.

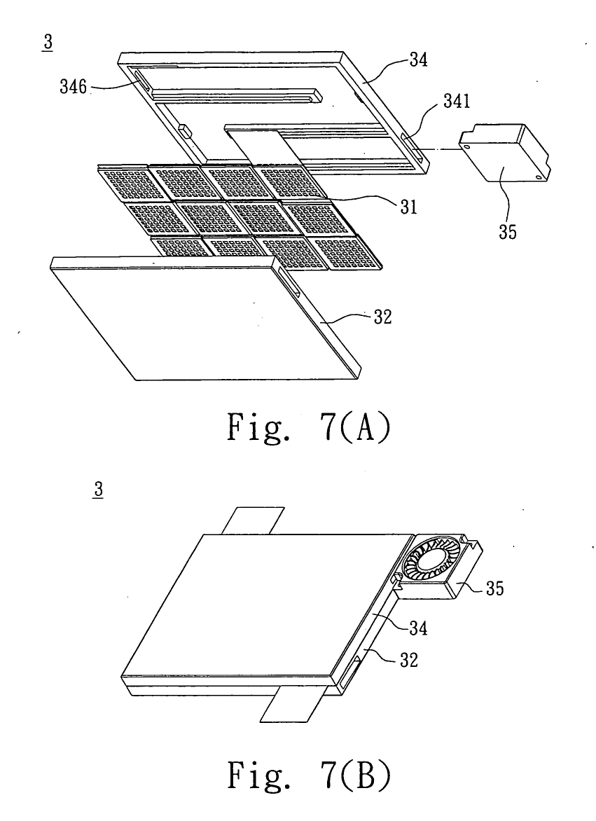

A further embodiment of a planar fuel cell assembly is illustrated in FIGS. 7(A) and 7(B). In this embodiment, the arrangement of the series-connected fuel cell units 31 and the channel-forming plate 32 included therein are similar to those shown in FIG. 5, and are not to be redundantly described herein. However, another channel-forming plate 34 is provided on the fuel cell units 31 and the channel-forming plate 32. The structure of the channel-forming plate 34 is substantially the same as that of the channel-forming plate 32. The arrangement of the channel-forming plate 34 facilitates preventing the fuel cell units from exposing to the ambient dust and moisture when the fuel cell assembly is used outdoors. For a purpose of enhancing amount of the supplied oxygen molecules and thus increasing the reaction in the cathode, a blower 35 is provided at the inlet 341 of the channel-forming plate 34. The flow pressure of the supplied air can be also further increased if the diameter of the outlet 346 of the channel-forming plate 34 is smaller that of the inlet 341. By the way, some marks, pictures, slogans or warning phrases can be printed on the outer surface of the channel-forming plate 34, depending on the requirement.

From the above description, the planar fuel cell assembly of the present invention is assembled by a plurality of fuel cell units connected in series and at least one channel-forming plate. For the individual fuel cell unit, the specific structures of the meshed metal plate 311 and the membrane-electrolyte assembly (MEA) 312 are advantageous for mass production of the planar fuel cell assembly. In addition, the arrangement of the decorative plate 33 facilitates sealing the fuel cell units and prevents leakage of the fuel, and the process of fixing the respective components of the planar fuel cell assembly 3 is more convenient and simpler when using the ultrasonic welding technique. Alternatively, the arrangement of the additional channel-forming plate 34 facilitates preventing the fuel cell units from exposing to the ambient dust and moisture and thus the pot life of the planar fuel cell assembly 3 is increased. Since the bulky metal frame and the bipolar plate used in the conventional fuel cell assembly are omitted, the overall weight of the present planar fuel cell assembly is reduced. Furthermore, the meshed metal plate 311 is rigid enough for supporting and fixing the membrane-electrolyte assembly (MEA) 312, and the fuel cell units 31 can be effectively secured on the supporting blocks 325 of the channel-forming plate 32.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A planar fuel cell assembly comprising:
a plurality of fuel cell units connected in series, each fuel cell unit comprising a meshed metal plate and a membrane-electrolyte assembly, said membrane-electrolyte assembly of each fuel cell unit having a first side in contact with a second portion of said meshed metal plate and a second side in contact with a first portion of said meshed metal plate of an adjacent fuel cell unit; and
a first channel-forming plate cooperating with said plurality of fuel cell units to define a channel for flowing a fluid fuel therethrough.

2. The planar fuel cell assembly according to claim 1 wherein said meshed metal plate of each fuel cell unit is made by punching a plurality holes in a metal piece.

3. The planar fuel cell assembly according to claim 1 wherein said first channel-forming plate is integrally formed of a plastic material by an injection molding process.

4. The planar fuel cell assembly according to claim 1 wherein each membrane-electrolyte assembly includes an anode, a proton exchange membrane and a cathode.

5. The planar fuel cell assembly according to claim 1 wherein said fluid fuel is in a gaseous or liquid state.

6. The planar fuel cell assembly according to claim 1 wherein said first portion and said second portion of said meshed metal plate are disposed at different levels by a gap.

7. The planar fuel cell assembly according to claim 6 wherein an edge of said membrane-electrolyte assembly is bonded to a connection portion between said first portion and said second portion of said meshed metal plate.

8. The planar fuel cell assembly according to claim 7 wherein said edge of said membrane-electrolyte assembly is bonded to said connection portion via an adhesive material.

9. The planar fuel cell assembly according to claim 8 wherein said second side of said membrane-electrolyte assembly is in contact with said first portion of said meshed metal plate of said adjacent fuel cell unit such that the top surface of said first portion of said adjacent fuel cell unit is substantially at the same level as that of said fuel cell unit.

10. The planar fuel cell assembly according to claim 1 wherein said first channel-forming plate comprises a depression portion enclosed by protruding edges thereof and a plurality of raised rods provided on said depression portion, wherein said raised rods along with said depression portion and said protruding edges define said channel for flowing said fluid fuel therethrough.

11. The planar fuel cell assembly according to claim 10 wherein a plurality of supporting blocks are disposed beside said protruding edges and said raised rods for supporting said plurality of fuel cell units.

12. The planar fuel cell assembly according to claim 11 wherein said plurality of fuel cell units are connected with said supporting blocks via an adhesive material.

13. The planar fuel cell assembly according to claim 1 further comprising a decorative plate disposed on said plurality of fuel cell units and said first channel-forming plate.

14. The planar fuel cell assembly according to claim 13 wherein said decorative plate and said first channel-forming plate are bonded together by means of an ultrasonic welding technique.

15. The planar fuel cell assembly according to claim 13 wherein said decorative plate is secured to said first channel-forming plate by tenons, screws or resilience sheets.

16. The planar fuel cell assembly according to claim 13 wherein said decorative plate is made of a plastic material.

17. The planar fuel cell assembly according to claim 13 wherein said first channel-forming plate further comprises weld lines corresponding to the periphery of said plurality of fuel cell units so as to facilitate sealing said fuel cell units and prevent leakage of said fluid fuel.

18. The planar fuel cell assembly according to claim 1 further comprising a second channel-forming plate disposed on said plurality of fuel cell units and said first channel-forming plate, the structures of said second channel-forming plate and said first channel-forming plate being substantially identical.

19. The planar fuel cell assembly according to claim 18 further comprising a blower disposed at an inlet of said second channel-forming plate for enhancing the flow rate of the air flowing through said second channel-forming plate.

20. The planar fuel cell assembly according to claim 1 further comprising two current collectors connected to the two terminal fuel cell units and acting as the current output terminals of said planar fuel cell assembly.
